(19) United States
(12) Patent Application Publication
(10) Pub. No.: US 2015/0032400 A1
(43) Pub. Date: Jan. 29, 2015

(54) METHOD FOR MANAGING A THERMODYNAMIC DEVICE FOR A MOTOR VEHICLE, SYSTEM, PROGRAM, RECORDING MEDIUM AND ASSOCIATED VEHICLE

(71) Applicant: RENAULT s.a.s., Boulogne-Billancourt (FR)

(72) Inventors: Eudes Quetant, Guyancourt (FR); Virginie Goutal, La Celle Les Bordes (FR)

(73) Assignee: RENAULT s.a.s., Boulogne-Billancourt (FR)

(21) Appl. No.: 14/376,570

(22) PCT Filed: Mar. 5, 2013
(86) PCT No.: PCT/FR13/50466

§ 371 Date: Aug. 4, 2014

(30) Foreign Application Priority Data
Mar. 5, 2012 (FR) 1251973

(51) Int. Cl. G01M 3/00; G01F 25/00

(52) U.S. Cl. CPC G01M 3/007; G01F 25/00
USPC 702/100

(57) ABSTRACT

A method for managing a thermodynamic device for a motor vehicle, a system, a program, a recording medium and an associated vehicle. The method manages a thermodynamic device for a motor vehicle including a heat-transfer fluid circuit, and includes an initial verification in which a functional state or a failure state in the heat-transfer fluid circuit is detected by taking a first measurement of pressure of a heat-transfer fluid in the heat-transfer fluid circuit and comparing same with a first threshold and, after the initial verification during which a failure state was detected, performs confirming the failure state during which a new verification is carried out by taking a second pressure measurement and comparing same with a second threshold.

### TECHNICAL FIELD OF THE INVENTION

The invention relates to the field of motor vehicles and more particularly to the management of an on-board thermodynamic device.

A more particular subject of the invention is a method for managing a thermodynamic device for a motor vehicle, notably of the heat pump type, comprising a heat-transfer fluid circuit, said method comprising an initial verification step in which a functional status or a defective status for the heat-transfer fluid circuit is detected as a function of a first measurement of the pressure of said fluid and the comparison thereof against a first threshold.

### PRIOR ART

In the field of motor vehicles, thermodynamic devices are used notably to improve the level of comfort of the passenger or passengers in the vehicle interior.

Such thermodynamic devices, of the heat pump type, comprise a heat-transfer fluid circuit generally associated with a compressor to cause the heat-transfer fluid to circulate through the circuit. Such a fluid, according to the mode of operation of the associated thermodynamic device, allows the air in the vehicle interior to be heated, cooled or dried, or alternatively allows the deicing of the device itself.

Of course, such a thermodynamic device may be subject to breakdowns such as the loss of heat-transfer fluid following a leak, or quite simply a lack of heat-transfer fluid in the associated circuit. This kind of breakdown often leads to premature compressor degradation.

To alleviate this problem, there has been proposed a method for managing a thermodynamic device for a motor vehicle, of the heat pump type, said method comprising an initial verification step in which a functional status or a defective status for the heat-transfer fluid circuit is detected. This detection is performed as a function of a first measurement of the pressure of said fluid and the comparison thereof against a threshold.

In fact, if the measured pressure is below the threshold, the device is considered to have a defective status, and if the measured pressure is above the threshold, the device is considered to have a functional status. In the defective status, operation of the thermodynamic device is not possible, for example because the starting of the compressor thereof is inhibited.

However, it has been found that, under certain considerations, a defective status may be detected when in fact there is no leak.

### OBJECT OF THE INVENTION

The object of the invention is to propose a solution that makes it possible to avoid wrongly detecting a defective status of a thermodynamic device of the heat pump type in a motor vehicle, and thus making it possible to increase the probability of the device being started.

To this end, provision has been made for the method to comprise, after the initial verification step during which a defective status has been detected, a confirmation step of confirming the status, during which step a further verification is carried out by performing a second measurement of the pressure and comparing same against a second threshold.

According to one embodiment, the heat-transfer fluid is heated during the confirmation step.

According to another embodiment, the heat-transfer fluid is circulating, or made to circulate, during the confirmation step.

Advantageously, during the confirmation step
the thermodynamic device is active for a defined time period,
a plurality of further verifications are performed during the time period so that if one of the further verifications leads to detection of a functional status, the detected defective status is invalidated, and if at the end of the time period the detected status is still the defective status, the latter status is validated.

According to one embodiment, if the defective status is validated, a memory-storage step of storing the defective status of the thermodynamic device in a memory is performed so as to inhibit subsequent activation of one of the modes of operation of the thermodynamic device. Furthermore, the method may comprise an erasing step during which the memory is erased if the pressure of the heat-transfer fluid changes in such a way that, after the memory-storage step and as a function of the first threshold and/or of the second threshold it enters a range indicative of the thermodynamic device having a functional status.

For preference, during the initial verification step the functional status corresponds to a value for the first pressure measurement that is above the first threshold, and the defective status corresponds to a value for the first pressure measurement that is below the first threshold.

For preference, during each further verification the functional status corresponds to a value for the second pressure measurement that is above the second threshold, and the validated defective status corresponds to a value for the second pressure measurement that is below the second threshold.

Advantageously, the first threshold and the second threshold are indicative of the same heat-transfer fluid pressure value.

Advantageously, a further verification of the confirmation step is performed only if an external reference temperature external to the thermodynamic device is below a threshold temperature.

Advantageously, a memory-storage step of storing the validated defective status of the thermodynamic device in a memory is performed in such a way as to inhibit subsequent activation of one of the modes of operation of the thermodynamic device if the external reference temperature is above the threshold temperature and if also a defective status is detected during the initial verification step. For preference, the threshold temperature is a negative temperature.

According to one particular embodiment, the thermodynamic device comprises a first set of modes comprising a heating mode and advantageously a deicing mode of the thermodynamic device, and a second set of modes comprising an air conditioning mode and advantageously a dehumidifying mode, the first and second sets being associated respectively with first and/or second pressure thresholds which are distinct according to the desired mode of operation.

In fact, the defective status validated during the confirmation step may correspond to a leak of heat-transfer fluid from the heat-transfer fluid circuit or to an insufficient quantity of heat-transfer fluid in said heat-transfer fluid circuit.

Advantageously, the pressure of the heat-transfer fluid is deliberately increased during the confirmation step.

The invention also relates to a system for a vehicle of the motor vehicle type, comprising a thermodynamic device comprising a heat-transfer fluid circuit, a verification element configured to detect a functional status or a defective status of the heat-transfer fluid circuit and a confirmation element configured to confirm a defective status once the verification element has detected same.

Advantageously, the system comprises a control unit configured to implement the management method.

According to one particular embodiment, the system may comprise a compressor acting on the heat-transfer fluid in order to cause it to circulate through the heat-transfer fluid circuit.

The invention also relates to a computer-readable data recording medium on which is recorded a computer program comprising computer program code means for implementing the steps of the management method.

The invention also relates to a computer program comprising a computer program code means suited to performing the steps of the management method when the program is executed by a computer.

Finally, the invention also relates to a vehicle incorporating said system. The thermodynamic device is then advantageously configured to act on the level of comfort in the vehicle interior.

### BRIEF DESCRIPTION OF THE DRAWINGS

Further advantages and features will become more clearly apparent from the following description of some particular embodiments of the invention which are given by way of nonlimiting examples and depicted in the attached drawings in which:

FIG. 1 is a simplified diagram of how the management method works,

FIG. 2 is a logarithmic graph of pressure against specific enthalpy for a fluid of the HF01 324yf type,

FIG. 3 illustrates a particular embodiment of step E2 of FIG. 1,

FIG. 4 illustrates a full diagram of an optimized mode of operation of the management method,

FIG. 5 schematically illustrates a system comprising a thermodynamic device for a motor vehicle.

### DESCRIPTION OF PREFERRED EMBODIMENTS OF THE INVENTION

Following various tests it was determined that the types of problem targeted in the prior art had a tendency to occur when the external temperatures were relatively low. This is because the specific low-pressure threshold is generally determined in order to detect a leak down to temperatures of close to 0° C. However, for temperatures that are more negative, and when the quantity of fluid is the same as the initial quantity, or reduced only very little, the pressure of the fluid at this negative temperature may be below the abovementioned threshold and thus trigger a false detection of a lack of fluid.

Thus, a method for the management of a thermodynamic device for a motor vehicle has been developed. For preference, the thermodynamic device is of the heat pump type. The thermodynamic device comprises a heat-transfer fluid circuit and the status of the thermodynamic device can also be verified in these circumstances.

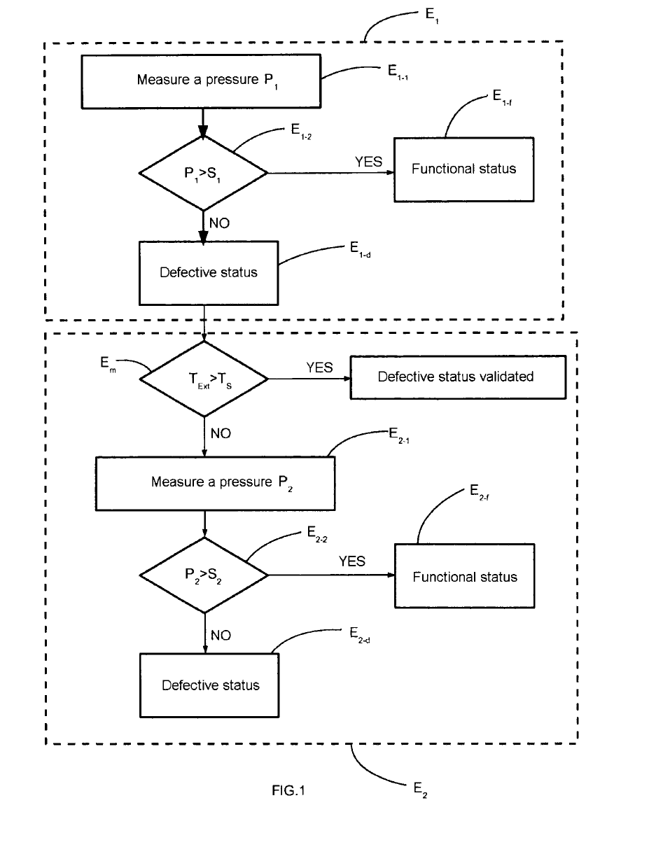

In FIG. 1, this method comprises, as in the prior art, an initial verification step E1 in which a functional status E1-f or a defective status E1-d for the heat-transfer fluid circuit is detected as a function of a first measurement E1-1 of the pressure P1 of said fluid and the comparison E1-2 thereof against a first threshold S1.

Advantageously, during the initial verification step E1 the functional status E1-f corresponds to a value for the first pressure measurement P1 that is above the first threshold S1 (YES output of E1-2), and the defective status E1-d corresponds to a value for the first pressure measurement P1 that is below the first threshold S1 (NO output of E1-2).

Furthermore, according to the invention, the method comprises, after the initial verification step E1 during which a defective status E1-d has been detected (NO output of E1-2), a confirmation step E2 of confirming the defective status E1-d, during which step a further verification is carried out by performing a second measurement E2-1 of the pressure P2 and comparing E2-2 same against a second threshold S2. Advantageously, during the confirmation step E2, the pressure of the fluid is deliberately increased. The confirmation step E2 may comprise one or more further verifications, or in other words, if the defective status is validated in the step E2-d (NO output from E2-2), the method may loop back at least once to the start of the confirmation step E2.

In fact, each further verification makes it possible to validate or invalidate the previously detected defective status. That allows the functional logic controller of a vehicle equipped with the thermodynamic device and with the method not to inhibit operation of the thermodynamic device unless it has carried out at least one additional verification. In fact, the defective status validated during the confirmation step may correspond to a leak of heat-transfer fluid from the heat-transfer fluid circuit or to an insufficient quantity of heat-transfer fluid in said heat-transfer fluid circuit.

During each further verification (in step E2), the functional status E2-f preferably corresponds to a value for the second pressure measurement P2 that is above the second threshold S2 (YES output from E2-2), and the validated defective status E2-d corresponds to a value of the second pressure measurement that is below the second threshold S2 (NO output from E2-2).

The first threshold S1 and the second threshold S2 may be indicative of the same or different pressure values for the heat-transfer fluid.

It will be appreciated from the foregoing that the probabilities of discriminating a diagnostics error are improved.

The behavioral study of the device, combined with diagnoses made in error during a single initial step as in the prior art, has demonstrated that, on a vehicle equipped with a heat pump, the saturation pressure of the heat-transfer fluid at rest corresponds to the external temperature that more or less corresponds to the ambient temperature. “At rest” should be understood to mean that the fluid is in a stable state and that the thermodynamic device is switched off. At very low ambient temperature, depending on the type of fluid used, for example of the R134a or HOF1 234yf type, the pressure of the heat-transfer fluid is below the pressure threshold that the system conventionally uses for identifying an insufficient quantity or a leak of heat-transfer fluid.

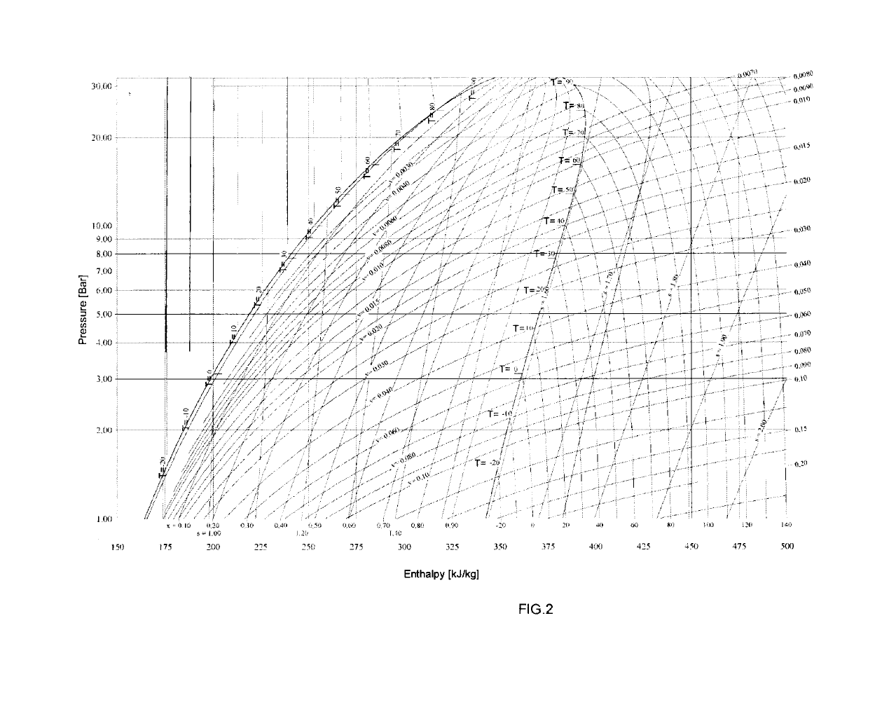

This behavioral study is verified by practical experience in the study of the property of a heat-transfer fluid and the quantity thereof within a fluid circuit. FIG. 2 illustrates a logarithmic graph of pressure (in bar) against specific enthalpy (in kJ/kg) for a fluid of type HF01 324yf. It highlights the characteristics of the fluid at various temperatures T in ° C., at s-values expressed in kJ/(kg K°) corresponding to isentropes, and at v-values of specific volume expressed in m³/kg. In the wet vapor zone and in the superheated zone there are isentropes. These are lines of equal entropy. An increase in entropy is a measure of the heat losses that take place during technical processes. It is a calorific parameter as is enthalpy and has a determined value in each state. The absolute magnitude is not defined. It is calculated from an arbitrary point, usually from the normal state (for R12: 0° C.). The units of entropy are kJ/kg·K. The isentropes occur mainly in the superheated-vapor zone and are very useful to those specializing in the study of cold. Compression in an ideal compressor, with no losses, takes place along these lines of equal entropy. The isentropes therefore make it possible to determine the ideal (theoretical) compression work P per kg of refrigerant by comparing the initial enthalpy and the final (post-compression) enthalpy. That allows conclusions to be drawn regarding the power actually absorbed by the compressor.

Thus, an analysis of FIG. 2 highlights the following results:
if the external temperature external to the fluid circuit is 0° C., the pressure, also referred to as the saturation pressure, of the heat-transfer fluid is around 3.1 bar, corresponding to the nominal value of the pressure in the heat-transfer fluid circuit (also referred to as being in the range of pressure in the loop). An under quantity of fluid may lead to an absolute pressure of 2.5 bar or even 2 bar. A significant leak will lead to a pressure identical to the outside pressure, namely usually 1.1 bar. Thus, for a thermodynamic device intended only to perform an air-conditioning function, i.e. to “create cold” and limited to the external temperature of 0° C., a minimum absolute-pressure threshold for detecting a small quantity of heat-transfer fluid (in this particular example referred to a as coolant) needs to be below 3.1 bar.
If the external temperature outside the fluid circuit is −10° C., the saturation pressure of the fluid is around 2.2 bar, corresponding to the nominal value of the pressure in the loop. An under quantity of fluid may lead to an absolute pressure of 2 bar, or even 1.5 bar. A significant leak will lead to a pressure identical to the external pressure, namely usually 1.1 bar. Thus, for air-conditioning systems with a heat pump mode operating down to external temperatures of −10° C., a minimum absolute-pressure threshold for detecting a small quantity of coolant needs to be below 2.2 bar.
If the external temperature is −20° C., the saturation pressure of the fluid is around 1.5 bar, corresponding to the nominal value for the pressure in the loop. An under quantity of fluid may lead to an absolute pressure of 1.3 bar or 1.2 bar for example. A significant leak will lead to a pressure identical to the pressure outside, namely usually 1.1 bar. For a thermodynamic device with a heat pump mode operating for example down to external temperatures of −20° C., a minimum absolute-pressure threshold for detecting a small quantity of coolant needs to be below 1.5 bar.

However, the pressure threshold used for detecting a defective status must not be too low because the lower the pressure threshold, the less able the system will be to detect instances of low fill. For example, if the pressure threshold is 1.7 bar, that is very much below the saturation pressure at 0° C., and so at 0° C. no instances of low fill quantity with pressures higher than 1.7 bar will be detected. Now, for the sake of the durability of the thermodynamic device and the associated performance thereof (thermal power, consumption), it is important that the fluid quantity level be high enough when the device is in operation.

It should also be noted that the pressure threshold used in the comparison must not be too low either because the method needs to be able to make a clear distinction between instances of failure of a pressure measurement sensor, for example a short circuit, and instances of very low pressure being detected, through the measurement technology and sensor-computer connection, and then cover the margin of error in the detection of the pressure (the spread on the sensor, the influence that external conditions have on the measurement, the spread on the voltage, errors in reconstituting the values from measurements within the computer, etc).

As a result of the foregoing, when a system is started or initialized from cold, the temperature of the heat-transfer fluid is substantially equal to that of the ambient temperature and this, by applying the perfect gas equation, may lead to a very low fluid pressure in the circuit even though the quantity of fluid is sufficient. This greatly limits the range of operation of the heat pump to a minimum temperature (of around −10° C. or −15° C. depending on the actual thresholds among the lowest ones).

Thus, in a first embodiment, it is possible, in combination with the method steps described hereinabove, to heat the heat-transfer fluid heated during the confirmation step, preferably before performing the further verification step. This heating causes a deliberate increase in the pressure of the heat-transfer fluid as aimed for hereinabove. This heating may be carried out by applying enough heat energy to raise the temperature of heat-transfer fluid to a normal operating temperature. If, at this normal operating temperature, the pressure is still not satisfactory, then the defective status is validated and, conversely, the defective status can be invalidated so that the thermodynamic device switches to a functional status. This heating can be performed using any suitable element known to those skilled in the art, for example employing a resistive thermal element. According to one particular example that uses heating, it may be possible to heat up all of the fluid by acting either on the entire loop without moving the fluid (i.e. by fitting one or more resistive element(s) along the entire path followed by the fluid), or acting on part of the loop (the resistive element sited locally for example), but by causing the fluid to circulate for a certain length of time so that it heats up uniformly. In the latter instance, a means needs to be found for causing the fluid to circulate without making excessive use of the compressor which is precisely the element that it is sought to protect, and so it is possible to add a pump dedicated to the circulating of the fluid, or to start up the compressor at a very low speed by positioning valves in such a way that there is no expansion (i.e. to limit the compression of the heat-transfer fluid).

Note that the method preferably requires good insulation of all of the components of the heat-transfer fluid circuit loop, primarily the pipes.

According to a second embodiment, the heat transfer fluid is circulating, or is made to circulate, during the confirmation step. This circulation may be performed by starting up a compressor associated with the heat-transfer fluid circuit, and thus bringing about the deliberate increase in the fluid pressure. The compressor then compress the fluid so that the latter reaches a pressure higher than the initial pressure thereof. The verification step is then referred to as dynamic.

Advantageously, during the confirmation step E2, the thermodynamic device is active for a defined time period and a plurality of further verifications are performed during the time period so that if one of the further verifications leads to detection of a functional status, the detected defective status is invalidated, and if at the end of the time period the detected status is still the defective status, the latter status is validated. This activation makes it possible, for example, to cause the heat-transfer fluid to circulate notably by starting the compressor, it being possible for this activation to take place before or during the further verification during the confirmation step.

Thus, in the confirmation step, operation of the thermodynamic device is authorized, for example at low temperature, even if the pressure is very low, and is authorized for a sufficient minimum length of time that corresponds to the time period in which, if the measured pressure remains below a certain threshold the method inhibits operation of the thermodynamic device, i.e. for example by switching off the compressor. This affords the advantage of avoiding systematically inhibiting the thermodynamic device if the external temperature is low and at the same time there is no lack of fluid. What is meant by a “low temperature” is a temperature at which it is not possible to tell whether or not the heat-transfer fluid circuit is defective; this temperature is therefore dependent on the fluid chosen. A person skilled in the art facing the problem and solution set out hereinabove will therefore be able to determine what a “low temperature” means.

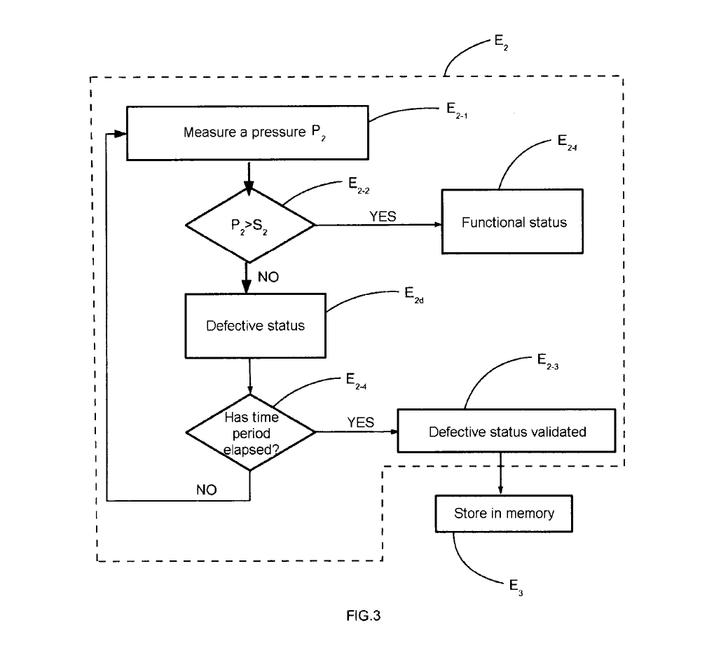

FIG. 3 represents in greater detail step E2 of FIG. 1, reusing the same elements and applying the same references to them. In this FIG. 3, after measuring the pressure P2 (step E2-1) and detecting a defective status E2d following the step E2-2 if, advantageously, after a time period (YES output from step E2-4), the defective status is still present then it is validated E2-3 (for example at the end of step E2). In cases where the time period is not used, the defective status can be validated directly upon the first detection thereof during the confirmation step E2.

In general, a memory-storage step E3 of storing the validated defective status of the thermodynamic device in a memory is performed in such a way as to inhibit subsequent activation of one of the modes of operation of the thermodynamic device. This memory-storage step carries an advantage in cases where, if a validated defective status E2-3 is recorded in the memory that makes it possible to avoid the need for a further similar test. Thus, even before the initial verification step is performed, or before the confirmation step, it is possible to verify the content of the memory and directly inhibit subsequent operation. This carries the advantage of safeguarding the integrity of the elements that cause the fluid to circulate, for example the compressor. Further, in FIG. 3, in the event of a further detection of a defective status in step E2d and in combination with the idea of a time period, a step E2-4 is performed to test whether the time period has elapsed, if YES, the defective status is validated (step E2-3), and if NO then the method loops back to step E2-1 where a further measurement of the pressure P2 is carried out.

According to one particular embodiment associated with the memory-storage step, the method may further comprise an erasing step during which the memory is erased if the pressure of the heat-transfer fluid changes in such a way that, after the memory-storage step and as a function of the first threshold and/or of the second threshold, it enters a range indicative of the thermodynamic device having a functional status. This carries the advantage of not requiring specific intervention by the after sales department to erase this stored memory if the threshold becomes acceptable again, or after the quantity of fluid has been adjusted and/or after any fluid leak has been repaired.

In order to improve the method, a further verification is performed in confirmation step E2 of FIG. 1 only if an external reference temperature Text external to the thermodynamic device is below a threshold temperature Ts (FIG. 1). In other words, upon detection of a defective status E1-d, there may be, during step E2 and preferably immediately following the invoking of step E2, a step Em of measuring the external temperature Text and of comparing same against a threshold Ts so that if the external temperature Text is above the threshold Ts then it is considered that the temperature should have no negative influence on the detection of the status and so the defective status is validated directly at the YES output from step Em. At the NO output from step Em, the confirmation step E2 is performed as described previously.

For the same advantageous reasons as were described hereinabove during the memory-storage step E3 of FIG. 3, if the external reference temperature Text is above the threshold temperature Ts (step Em) and if also a defective status is detected during the initial verification step (E1), the defective status validated at the YES output from step Em is stored in a memory so as to inhibit subsequent activation of one of the modes of operation of the thermodynamic device.

In general, the threshold temperature Ts is a negative temperature. However, its value will be adapted according to the type of heat-transfer fluid used and may therefore also be positive.

In general, the thermodynamic device comprises, on the one hand, a first set of modes comprising a heating mode and advantageously a deicing mode of the thermodynamic device, and, on the other hand, a second set of modes comprising an air conditioning mode and advantageously a dehumidifying mode, the first and second sets being associated respectively with first and/or second pressure thresholds which are distinct according to the desired mode of operation. Advantageously, each mode of operation can be inhibited selectively, or several modes of operation can be inhibited upon detection of a validated defective status. In fact, depending on the mode chosen, the fluid circuit may adapt (for example be shortened by isolating certain parts), and therefore having thresholds with different values becomes more relevant.

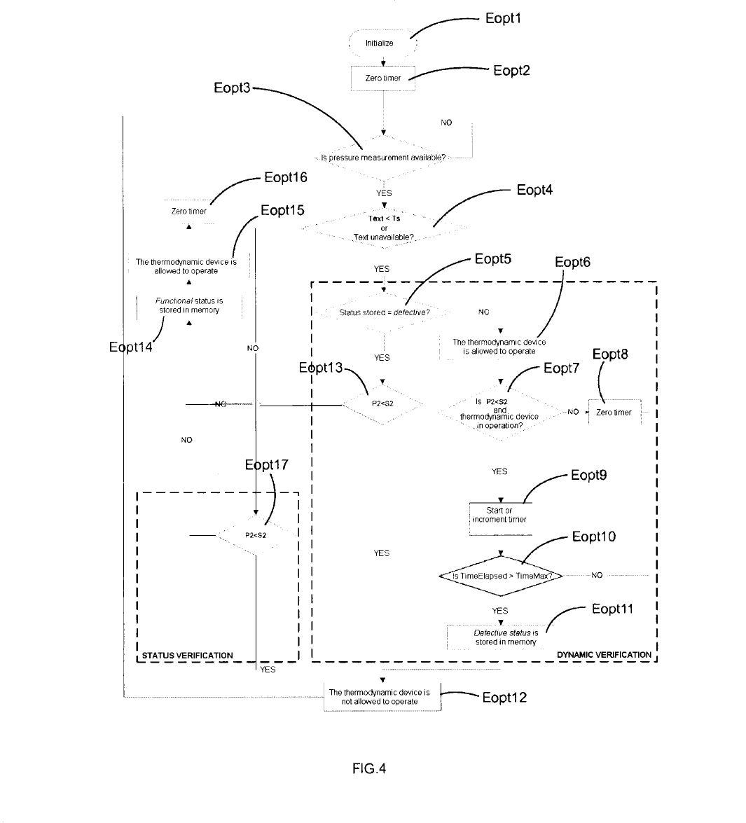

For preference and the sake of optimization, the management method corresponds to that illustrated in FIG. 4. Thus it may initially comprise a step Eopt1. The step Eopt1 is followed by the zeroing of a timer in a step Eopt2. Following the step Eopt2 a step Eopt3 makes it possible to verify whether the pressure measurement is available, and if it is not (NO output) then step Eopt3 loops back on itself, whereas if it is available (YES output) then a test on the external temperature Text is performed in a step Eopt4. Step Eopt3 may advantageously perform step E1 as described hereinabove. This test corresponds to verifying whether the external temperature Text is below a threshold Ts or whether the external temperature Text is not available. On the YES output a step Eopt5 verifies the status of a parameter of the memory containing the value of a variable indicative of a functional or defective status validated beforehand. If, in step Eopt5, the status stored in the memory is not defective (NO output) then the thermodynamic device is switched on (step Eopt6), for example by causing the fluid to circulate by switching on the compressor. Following the startup in step Eopt6, the pressure P2 of the heat-transfer fluid is measured again and reverified by comparison against the threshold S2, advantageously with a test on the operation of the thermodynamic device to make sure that the thermodynamic device is operating correctly, in a step Eopt7. If the pressure P2 is above the associated threshold S2 or, advantageously, if the thermodynamic device is not operating, then the timer is rezeroed at step Eopt8. At the YES output from step Eopt7 (P2 below S2 and advantageously the starting-up of the thermodynamic device is confirmed) then the timer is started, or updated if already started, in a step Eopt9. Following the step Eopt9, the value associated with the time elapsed TimeElapsed of the timer is compared against a maximum time TimeMax (step Eopt10) so that if TimeElapsed is above TimeMax then the memory is updated and the validated defective status is written to same (step Eopt11) and then step Eopt12, in which operation of the thermodynamic device in at least one of the modes thereof is forbidden, is performed. If TimeElapsed is lower than TimeMax, then the method moves back to step Eopt3. On the YES output from step Eopt5, i.e. when the memory was already indicating a defective status, a further test on the pressure is performed by a new measurement of pressure P2 and by comparing this measurement against the threshold S2 (Eopt13). If the freshly measured pressure P2 is still below the threshold S2 (YES output) then operation of the thermodynamic device, in at least one of the modes thereof, is forbidden by switching to step Eopt12. If, during the verification at step Eopt13 the pressure P2 is above the threshold (NO output from Eopt13) then the status in the memory switches to functional (step Eopt14) then the thermodynamic device is allowed to operate in step Eopt15 following on from step Eopt14, then the timer is, if appropriate, rezeroed in a step Eopt16. Moreover, on the NO output from step Eopt4 in the event that the external temperature is above the threshold temperature Ts then a static test is performed (step Eopt17) in which test the pressure P2 is measured again and compared against the threshold S2, if the pressure P2 is below the threshold S2 then step Eopt12 is performed, if not the steps Eopt14, Eopt15, Eopt16 are carried out in succession.

After steps Eopt8, Eopt12 and Eopt16, the method returns to step Eopt3.

The step Eopt17 forms part of a test referred to as a static test, and steps Eopt5-6-7-8-9-10-11-12-13 form part of a test referred to as a dynamic test.

The switching-on of the thermodynamic device, for example via the compressor, can be performed by commands applied to the compressor for one or more modes of operation of the heat pump. The commands may be implemented notably in steps Eopt12 and Eopt15 via a parameter associated with these steps and which may group together both inhibition caused by dynamic detection of low pressure or inhibition due to static detection.

In general, comparing the external temperature against a threshold makes it possible, during the confirmation step, either to perform a simple further verification involving a further measurement of the pressure and a further comparison (if the measured temperature is above the threshold), or, if the external temperature is below the threshold, performing a further verification of dynamic type, namely one during which the pressure of the fluid is deliberately increased (for example by heating or by starting the compressor).

The parameter corresponding to the validated functional or defective status can be used to inhibit operation of the heat pump:
either by acting on the compressor command, forcing it to 0 for one or more heat pump modes
or by acting on the heat pump mode that is not authorized (either one mode not authorized or several modes not authorized or no mode authorized)
or by acting on both.

According to an alternative form that can be applied to all of the foregoing and that can be derived from FIG. 4, the pressure threshold used in the comparison steps may be a function of the external temperature. Thus, the method may further comprise a step of determining the first pressure threshold advantageously associated with a static verification and/or the second pressure threshold advantageously associated with a dynamic verification according to an external temperature measurement. This determining step may for example be performed for a first time when the method is initialized prior to the initial verification step or, advantageously, may be applied throughout the use of the device so as to adapt the pressure thresholds to suit the external temperature. Another advantage of these thresholds being a function of the external temperature is for example that the fluid fill level below which the method inhibits the system can be rendered consistent whatever the eternal temperature (specifically, for example, a loss of one and the same quantity of fluid may, at an ambient temperature of 0° C., correspond to a pressure of 2.5 bar and, at an ambient temperature of −10° C., correspond to a lower pressure).

In the present method, the pressure thresholds and, where appropriate, temperature thresholds, may build some hysteresis into the operating logic. The time period, the pressure, temperature and compressor operating speed thresholds may be calibrated and specific to each of the modes of the system.
For example, the hysteresis on temperature makes it possible to prevent the system sometimes using static detection and sometimes dynamic detection as the ambient temperature fluctuates about the associated threshold, as such behavior would for example cause the compressor to run for a few seconds (when Text<Ts) then stop (when Text>Ts), resetting the timer to zero, then restarting it (when Text>Ts), etc. Thus, the condition on the temperature uses two thresholds Ts1 and Ts2 with Ts1>Ts2 using the following logic: if Ts>Ts2 then the threshold is Ts2; if thereafter Ts<Ts2 then the threshold becomes Ts1; and vice versa. The same principle applies in the case of hysteresis on pressure in which case two pressure thresholds would be used in a similar way.

The method may also permit one or more dynamic verification steps after initialization thereof and on subsequent initializations (or at the next demand for the mode that requires dynamic detection), as long as a certain number of dynamic verifications does not cross a specified threshold. This number can be rezeroed next time the system is initialized, or alternatively at the same time as the memory storage in the functional status.

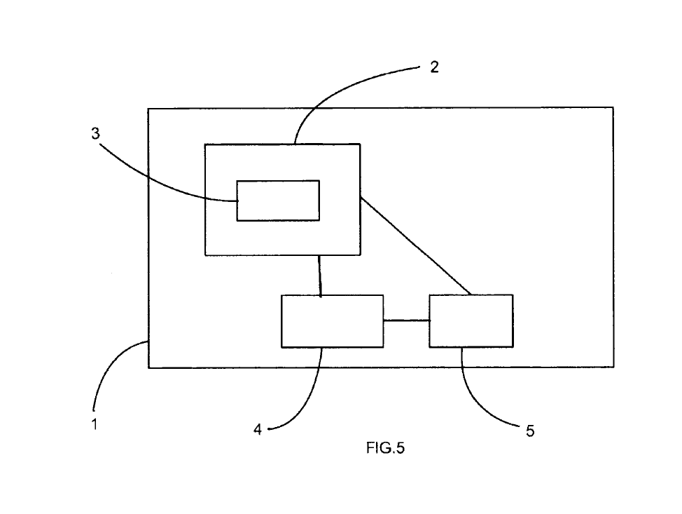

The device can be installed in a system for a vehicle of the motor vehicle type illustrated in FIG. 5. Such a system 1 comprises a thermodynamic device 2 of the heat pump type, comprising a heat-transfer fluid circuit 3 and a verification element 4 configured to detect a functional status or a defective status of the heat-transfer fluid circuit 3. The system further comprises a confirmation element 5 configured to confirm a defective status once same has been detected by the verification element. The thermodynamic device 2 may also be of some type other the heat pump type provided it contains a mode that needs to be functional at an ambient temperature that is such that the saturation pressure of the fluid at this temperature is close to or below the detection threshold for a low fill level that is adequate for a higher temperature, or adequate for another of its modes.

The system may comprise a control unit configured to implement the method as described hereinabove in its various alternative forms, and so the various steps can be performed by elements configured in a way suitable for performing said steps.

The system may comprise a compressor acting on the heat-transfer fluid in order to cause it to circulate through the heat-transfer fluid circuit. The other elements that make up the heat pump, which are well known to those skilled in the art, will not be described.

Furthermore, a computer-readable data recording medium that can be read by one or more computer(s) and on which a computer program is recorded may comprise computer program code means for implementing the steps of the management method.

In general, the computer program may comprise a computer program code means suited to performing the steps of the management method.

The stored values may be accessible to the user or to another individual operating on the system, for example via a diagnostics tool connected to the vehicle network or to the computer.

The system may notably be incorporated into a motor vehicle and the thermodynamic device may be configured to act on the level of comfort in the vehicle interior (for example according to the modes of operation mentioned hereinabove).

The system may if appropriate comprise a pressure sensor sensing the pressure of the heat-transfer fluid and an external-temperature temperature sensor, the measured values from which are used in the management method.

A static verification and a dynamic verification have been described hereinabove; these verifications may share the same device-status storage memory or have different memories.

1-22. (canceled)

23. A method for managing a thermodynamic device for a motor vehicle including a heat transfer fluid circuit, the method comprising:
an initial verification in which a functional status or a defective status for the heat transfer fluid circuit is detected as a function of a first measurement of pressure of a heat transfer fluid in the heat transfer fluid circuit and a comparison thereof against a first threshold; and
after the initial verification during which a defective status has been detected, a confirmation of confirming the defective status, during which a further verification is carried out by performing a second measurement of the pressure and comparing same against a second threshold.

24. The method as claimed in claim 23, wherein the heat transfer fluid is heated during the confirmation.

25. The method as claimed in claim 23, wherein the heat transfer fluid is circulating, or made to circulate, during the confirmation.

26. The method as claimed in claim 23, wherein during the confirmation:
the thermodynamic device is active for a defined time period,
a plurality of further verifications are performed during the time period so that if one of the further verifications leads to detection of a functional status, the detected defective status is invalidated, and if at an end of the time period the detected status is still the defective status, the latter status is validated.

27. The method as claimed in claim 23, wherein if the defective status is validated, a memory storage of storing the defective status of the thermodynamic device in a memory is performed to inhibit subsequent activation of one of modes of operation of the thermodynamic device.

28. The method as claimed in claim 27, further comprising an erasing during which the memory is erased if pressure of the heat transfer fluid changes such that, after the memory storage and as a function of the first threshold and/or of the second threshold, it enters a range indicative of the thermodynamic device having a functional status.

29. The method as claimed in claim 23, wherein during the initial verification the functional status corresponds to a value for the first pressure measurement that is above the first threshold, and the defective status corresponds to a value for the first pressure measurement that is below the first threshold.

30. The method as claimed in claim 23, wherein during each further verification the functional status corresponds to a value for the second pressure measurement that is above the second threshold, and the validated defective status corresponds to a value for the second pressure measurement that is below the second threshold.

31. The method as claimed in claim 29, wherein the first threshold and the second threshold are indicative of a same heat transfer fluid pressure value.

32. The method as claimed in claim 23, wherein the further verification of the confirmation is performed only if an external reference temperature external to the thermodynamic device is below a threshold temperature.

33. The method as claimed in claim 23, wherein a memory storage of storing the validated defective status of the thermodynamic device in a memory is performed to inhibit subsequent activation of one of modes of operation of the thermodynamic device if the external reference temperature is above the threshold temperature and if also a defective status is detected during the initial verification.

34. The method as claimed in claim 32, wherein the threshold temperature is a negative temperature.

35. The method as claimed in claim 23, wherein the thermodynamic device comprises a first set of modes comprising a heating mode and a deicing mode of the thermodynamic device, and a second set of modes comprising an air conditioning mode and a dehumidifying mode, the first and second sets of modes being associated respectively with first and/or second pressure thresholds which are distinct according to a desired mode of operation.

36. The method as claimed in claim 23, wherein the defective status validated during the confirmation corresponds to a leak of heat transfer fluid from the heat transfer fluid circuit or to an insufficient quantity of heat transfer fluid in the heat transfer fluid circuit.

37. The method as claimed in claim 23, wherein the pressure of the heat transfer fluid is deliberately increased during the confirmation.

38. A system for a vehicle of the motor vehicle type, comprising:
a thermodynamic device comprising a heat transfer fluid circuit and a verification element configured to detect a functional status or a defective status of the heat transfer fluid circuit; and
a confirmation element configured to confirm a defective status once the verification element has detected the defective status.

39. A system further comprising a control unit configured to implement the method as claimed in claim 23.

40. The system as claimed in claim 38, further comprising a compressor acting on the heat transfer fluid to cause the heat transfer fluid to circulate through the heat transfer fluid circuit.

41. A non-transitory computer readable data recording medium on which is recorded a computer program comprising computer program code means for implementing the method as claimed in claim 23.

42. A vehicle incorporating a system as claimed in claim 38.

43. The vehicle as claimed in claim 42, wherein the thermodynamic device is configured to act on a level of comfort in an interior of the vehicle.
